(19) United States
(12) Patent Application Publication
(10) Pub. No.: US 2012/0011970 A1
(43) Pub. Date: Jan. 19, 2012

(54) PLIERS WITH RESTORING FUNCTION

(76) Inventor: Jin Fu Chen, Dali City (TW)

(21) Appl. No.: 12/838,083

(22) Filed: Jul. 16, 2010

(51) Int. Cl. B25B 7/02

(52) U.S. Cl. 81/427

(57) ABSTRACT

Pliers with a restoring function include an elastic element and two pliers bodies. The elastic element has two urging ends. The two pliers bodies have two pinching heads, two handles, and two pivotal parts. Each of the pivotal parts has a recess and a pivotal hole. A pivotal element goes through the two pivotal holes. The elastic element is disposed in the two recesses and penetrated by the pivotal element. Both urging ends of the elastic element are on opposite sides of the two recesses to urge sidewalls of the recesses, thereby opening the pliers. A buffer region is designed in each of the recesses for the corresponding urging end. When the opening angle of the pliers is greater than that is supported by the elastic element, at least one urging end of the elastic element releases its urging against the recess sidewall and moves in the buffer region. The pliers become relaxed then.

### BACKGROUND OF THE INVENTION

1. Field of Invention

The invention relates to a pair of pliers with a restoring function and, in particular, to a pliers structure that can restore properly when the opening angle thereof is too large.

2. Related Art

Please refer to R.O.C. Pat. No. 168,952 for an improved structure of pliers. FIG. 19 is the first figure of R.O.C. Pat. No. 168,952. It has a torsional spring 61 whose both ends have an engaging end 611 bent in the radial direction, respectively. The torsional spring 61 is disposed in a groove 62. The two engaging ends 611 of the torsional spring 61 are urged between the two concave edges 621 of the groove 62. There is thus a constraint relation between the torsional spring 61 and the pliers. When a user imposes a force to hold the pliers, the elastic force of the torsional spring pushes the pliers open.

However, the above-mentioned design in the prior art has the following problems.

First, the engaging ends 611 on both ends of the torsional spring 61 are urged between the two concave edges 621 of the groove 62, therefore constrained and fixed. There is a constraint relation between the torsional spring 61 and the pliers. Such a design enables the pliers to open by an elastic force. However, if the opening angle of the torsional spring 61 does not reach the opening angle of the pressing ends 63 of the pliers, the torsional spring may be damaged if one forces the pressing ends 63 of the pliers to open. Even if there is temporarily no problem, the torsional spring will soon have elastic fatigue, greatly shortening its lifetime.

Secondly, to avoid the above-mentioned problem, one may design the opening angle of the torsional spring 61 to be the same as the opening angle of the pliers or larger. In that case, the angle between the two pressing ends 63 can reach its maximum when the pliers open. Even so, it still means that the user cannot dexterously hold and use the pliers with a single hand when the opening angle is too large (e.g., over 90 degrees). This is inconvenient in practice.

Thirdly, when the pliers are pushed by the torsional spring 61 to reach its maximum angle, the user has to impose a greater force on the pressing ends 63 of the pliers in order for the two pressing ends 63 to get closer and for the pinching ends 64 of the pliers to hold an object (screw and the like). However, if the user continues to use such pliers for some time, he may feel strengthless and numb in his hand. This lowers the overall work efficiency.

Please refer to R.O.C. Pat. No. 386,481 about pliers. FIG. 20 reproduces FIG. 1 of R.O.C. Pat. No. 386481. It has an elastic element (torsional spring) 65 with two foot parts 651 bent along a parallel axis. The two foot parts 651 are inserted into positioning holes 661, 671 of the body 66 and the fixing element 67. Thus, the elastic element 65 is constrained and fixed for the pliers to open.

However, R.O.C. Pat. Nos. 386,481 and 168,952 both has the problems mentioned before. The primary reason is that the two foot parts 651 of the elastic element 65 in R.O.C. Pat. No. 386,481 are positioned by the positioning holes 661, 671. Therefore, the elastic element 65 and the pliers have a constraint relation. Corresponding to the three problems mentioned before, R.O.C. Pat. No. 386,481 also has the problems of elastic fatigue, damages, and shorter lifetime for the torsional spring.

### SUMMARY OF THE INVENTION

An objective of the invention is to provide pliers with a restoring function. When the opening angle of the pliers is greater than the maximum opening angle of its elastic element, such as a torsional spring, the pliers have no effect on the torsional spring. This prevents the torsional spring from being over-stretched and resulting in elastic fatigue or even damages. Thus, the lifetime of the torsional spring is longer.

Another objective of the invention is to prevent the pliers from being opened to a large angle. Without any other external force, the pliers under the action of the torsional spring subtend a suitable angle for normal users to operate with a single hand within a certain angular range. It thus has a better gripping effect and convenience in use.

Yet another objective of the invention is, through the above-mentioned design, to reduce user's soreness and numbness after long time of use. This can enhance the overall work efficiency.

To achieve the above-mentioned objective, the invention includes an elastic element and two pliers bodies.

The elastic element has an urging end on each of its two sides.

The two pliers bodies have two pinching heads, two handles, and two pivotal parts for the two pliers bodies to cross each other. The two pivotal parts have an urging surface, respectively. The two urging surfaces are dug in to form recesses, respectively, that are surrounded and face each other. A pivotal hole near the corresponding recess goes through each of the two pivotal parts. A pivotal element goes through the two pivotal holes. The elastic element is disposed in the two recesses of the two pliers bodies. The elastic element surrounds the peripheral of the pivotal element. The two urging ends of the elastic element are on opposite sides of the two recesses to urge against the recess sidewalls, thus pushing the pliers open. A buffer region is formed in the two recesses corresponding to the two urging ends. When the opening angle of the pliers is greater than the maximum angle supported by the elastic element, at least one end of the two urging ends of the elastic element releases its urging on the recess sidewall. The urging end that releases its urging on the recess sidewall moves to the buffer region.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional view of the pliers in the first embodiment;

FIG. 2 is an exploded view of the disclosed pliers;

FIG. 3 is a cross-sectional view of the disclosed pliers when the torsional spring subtends its largest angle;

FIG. 4 is a cross-sectional view of FIG. 3 as viewed from between the handles toward the pivotal parts;

FIG. 5 is a schematic view of the pliers when they are closed to the end;

FIG. 6 is a schematic view of the pliers when the opening angle thereof is greater than the maximum angle of the torsional spring;

FIG. 7 is a schematic view of the pliers in FIG. 6;

FIG. 8 is a three-dimensional view of the pliers in the second embodiment;

FIG. 9 is an exploded view of the second embodiment;

FIG. 10 is a schematic view of the pliers when they are closed to the end;

FIG. 11 is a cross-sectional view of the disclosed pliers when the torsional spring subtends its largest angle according to the second embodiment;

FIG. 12 is a schematic view of the pliers when the opening angle thereof is greater than the maximum angle of the torsional spring according to the second embodiment;

FIG. 13 is an exploded view of the third embodiment;

FIG. 14 is a cross-sectional view of the closed pliers according to the third embodiment;

FIG. 15 is a cross-sectional view of the relaxed pliers when the elastic element pushes the pliers open according to the third embodiment;

FIG. 16 is another cross-sectional view of the relaxed pliers when the elastic element pushes the pliers open according to the third embodiment;

FIG. 17 is a schematic view of the pliers when the opening angle thereof is greater than the maximum angle of the elastic element;

FIG. 18 is another schematic view of the pliers when the opening angle thereof is greater than the maximum angle of the elastic element;

FIG. 19 is an exploded view of first conventional pliers; and

FIG. 20 is an exploded view of second conventional pliers.

### DETAILED DESCRIPTION OF THE INVENTION

The present invention will be apparent from the following detailed description, which proceeds with reference to the accompanying drawings, wherein the same references relate to the same elements.

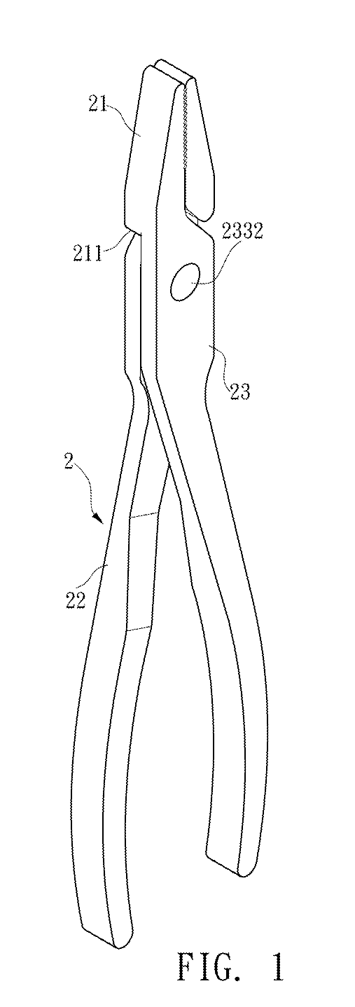

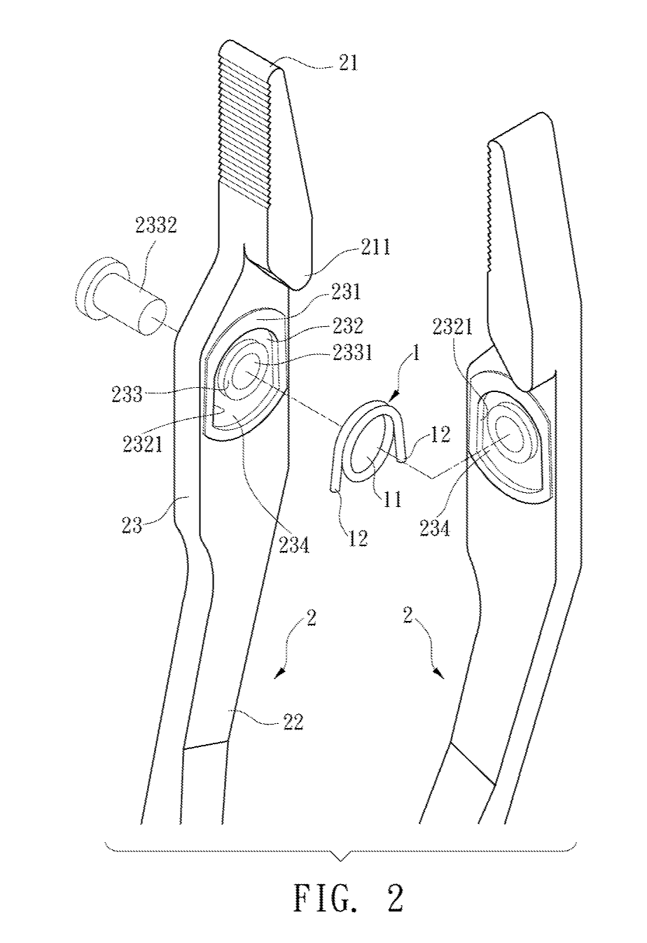

Please refer to FIGS. 1 to 4 for a first embodiment of the disclosed pliers. This pair of pliers has a structure similar to a vise. It includes an elastic element 1 and two pliers bodies 2.

The elastic element 1 in this embodiment is a torsional spring. Its center has a mounting hole 11. Both sides of the elastic element 1 have an urging end 12, respectively.

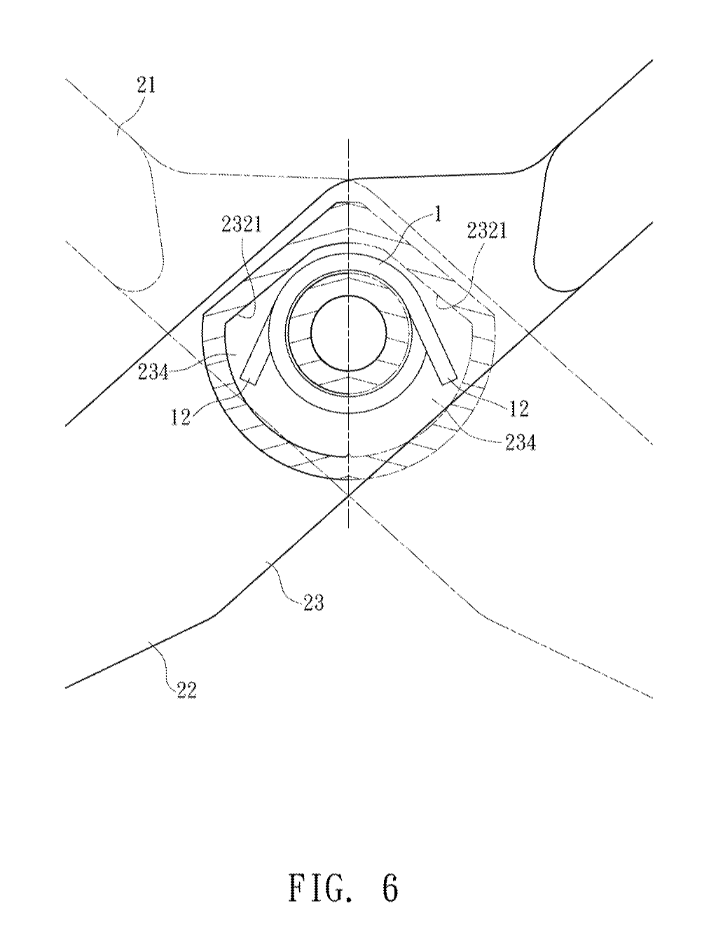

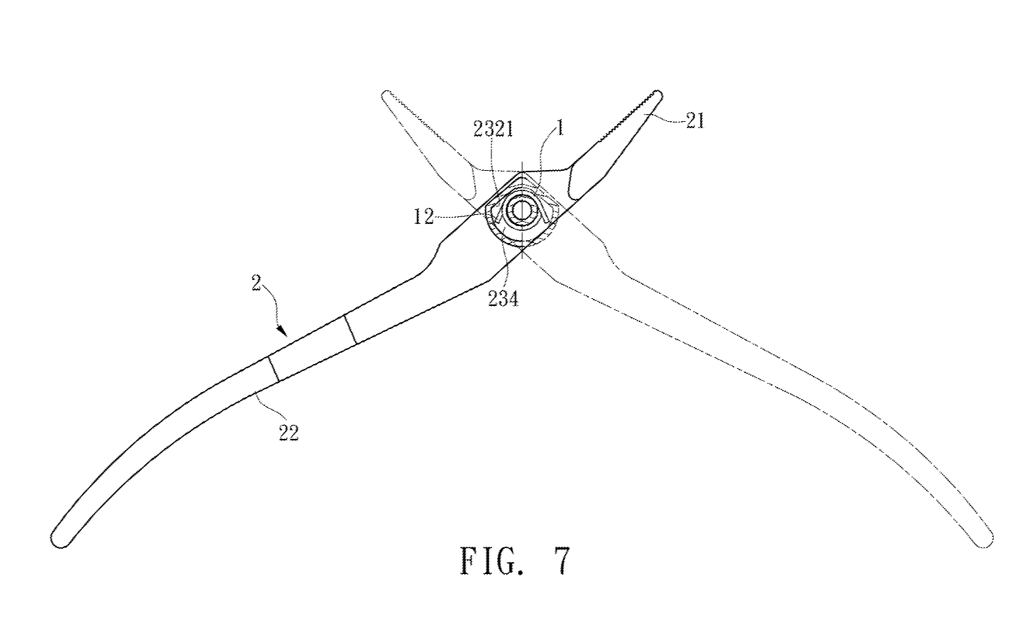

The two pliers bodies 2 have two pinching heads 21, two handles 22, and two pivotal parts 23 for the two pliers bodies 2 to cross each other. The two pivotal parts 23 have an urging surface 231, respectively. The two urging surfaces 231 are dug in to form recesses 232, respectively, that are surrounded and face each other. A pivotal hole 2331 near the corresponding recess 232 goes through each of the two pivotal parts 23. The two pivotal holes 2331 are connected by a pivotal element 2332. In this embodiment, the two recesses 232 are provided with protruding pillars 233, respectively, that are connected to each other. The pivotal hole 2331 for the pivotal connection of the two pliers 2 bodies goes through the center of each of the protruding pillars 233. The elastic element 1 is disposed in the two recesses 232 of the two pliers bodies 2. The elastic element 1 surrounds the peripheral of the pivotal element 2332. The mounting hole 11 of the elastic element 1 is penetrated through by the pivotal element 2332 and mounts on the two protruding pillars 233. The two urging ends 12 of the elastic element 1 are on opposite sides of the two recesses 232 to urge against the recess sidewalls 2321, thus pushing the pliers open. A buffer region 234 is formed in the two recesses 232 corresponding to the two urging ends 12. In this embodiment, each of the buffer regions 234 is inside the corresponding recess 232 in the vicinity of the handle 22. The opening direction of the two urging ends 12 of the elastic element is toward between the two handles 22. When the opening angle of the pliers is greater than the maximum angle supported by the elastic element 1, at least one end of the two urging ends 12 of the elastic element 1 releases its urging on the recess sidewall 2321. The urging end 12 that releases its urging on the recess sidewall 2321 moves to the buffer region 234. In this embodiment, as shown in FIGS. 6 and 7, when the pliers subtend a larger angle, the two urging ends 12 of the elastic element 1 are separate from the sidewalls 2321 of the recesses 232. Moreover, the maximum angle of the elastic element is about ½ to ⅓ of the maximum angle of the pliers.

Besides, the two pinching heads 21 extend out a stopping part 211 sideways, respectively. When the pliers open up to the maximum angle, the pivotal parts 23 are limited by the stopping parts 211.

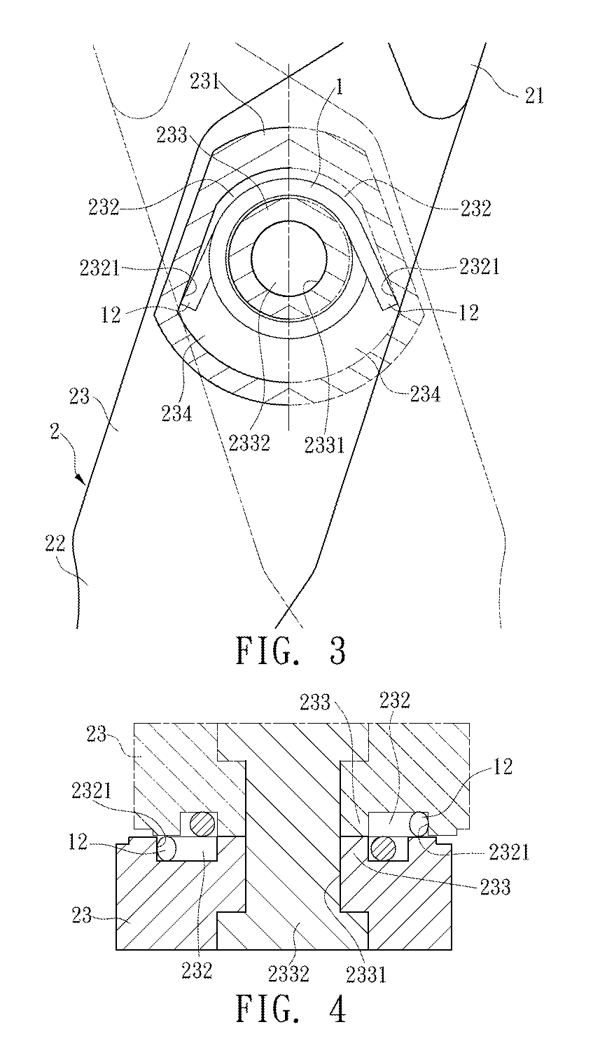

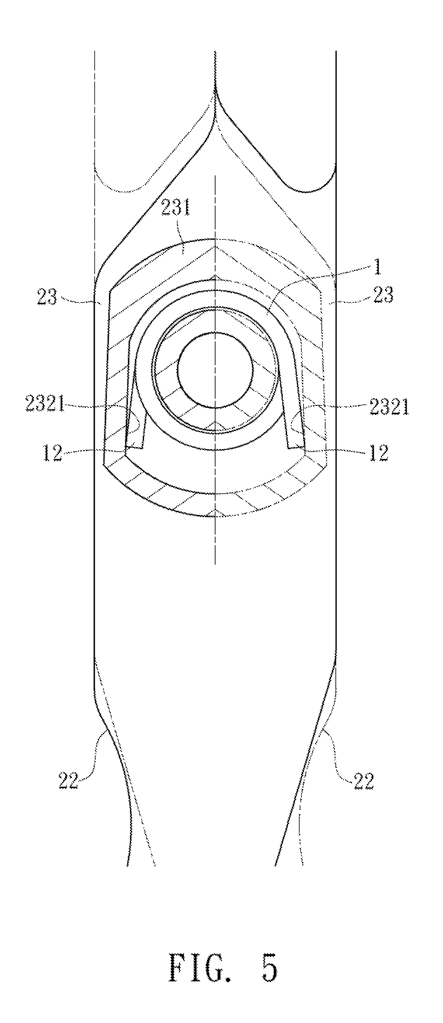

In practice, the use of the disclosed pliers is the same as usual. FIG. 5 shows the situation that the elastic element 1 is squeezed when the pliers are closed. FIG. 3 shows the situation when the pliers are released open and the opening angle of the pliers is roughly the same as the maximum angle of the elastic element 1. FIGS. 6 and 7 show that when the pliers are further open, the opening angle of the pliers becomes larger than the maximum angle of the elastic element 1. In this case, the pliers are not under the action of the elastic element 1. Both urging ends 12 of the elastic element 1 do not urge against the sidewalls 2321 of the recesses 232. They are in the buffer region 234.

In other words, the two urging ends 12 of the elastic element 1 in the invention actively urge against the sidewalls 2321 of the recesses 232. It is not like the torsional spring in the prior art that is completely constrained on its both ends. Therefore, when the pliers have a larger opening angle, the urging ends 12 of the elastic element 1 are separate from the sidewalls 2321 of the recesses 23. That is, the elastic element 1 cannot further push out the pliers. If one wants to further open the pliers, he has to pull them apart by hand or by gravity. Therefore, when the user uses his palm to hold the pliers and open them up, the pliers do not open up too much due to the elastic force of the elastic element 1. This guarantees the smoothness in use.

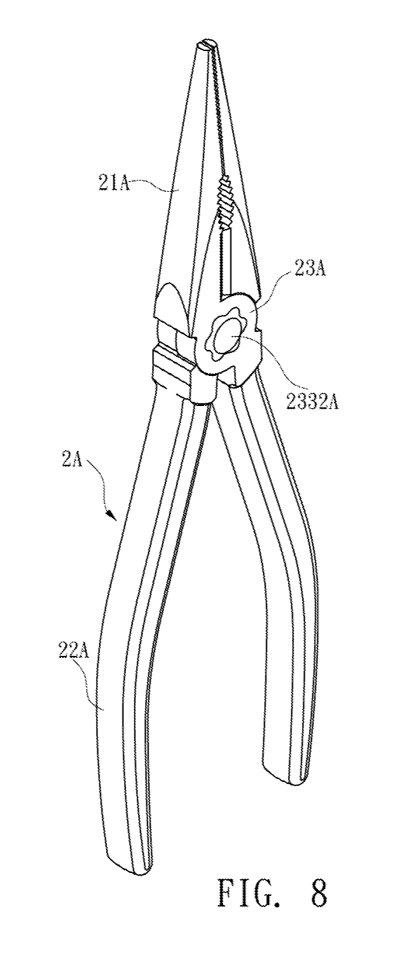

Please refer to FIGS. 8 to 12 for a second embodiment of the invention. In this embodiment, the pliers have a structure of nipper pliers. It includes an elastic element 1A and two pliers bodies 2A. The elastic element 1A is a torsional spring with a mounting hole 11A in its center and an urging end 12A on each of its two sides. The two pliers bodies 2A have two pinching heads 21A, two handles 22A, and two pivotal parts 23A for the two pliers bodies 2A to cross each other. The two pivotal parts 23A have an urging surface 231A, respectively. The two urging surfaces 231A are dug in to form recesses 232A, respectively, that are surrounded and face each other. A pivotal hole 2331A near the corresponding recess 232A goes through each of the two pivotal parts 23A. The two pivotal holes 2331A are connected by a pivotal element 2332A. In this embodiment, the two recesses 232A are provided with protruding pillars 233A, respectively, that are connected to each other. The pivotal hole 2331K for the pivotal connection of the two pliers bodies 2A goes through the center of each of the protruding pillars 233A. The elastic element 1A is disposed in the two recesses 232A of the two pliers bodies 2A. The elastic element 1A surrounds the peripheral of the pivotal element 2332A. The mounting hole 11A of the elastic element 1A is penetrated through by the pivotal element 2332A and mounts on the two protruding pillars 233A. The two urging ends 12A of the elastic element 1A are on opposite sides of the two recesses 232A to urge against the recess sidewalls 2321A, thus pushing the pliers open. An out-extending buffer region 234A is formed in the two recesses 232A Corresponding to the two urging ends 12A. In this embodiment, each of the buffer regions 234A is inside the corresponding recess 232A in the vicinity of the handle 22A. The opening direction of the two urging ends 12A of the elastic element 1A is toward between the two handles 22A. When the opening angle of the pliers is greater than the maximum angle supported by the elastic element 1A, at least one end of the two urging ends 12A of the elastic element 1A releases its urging on the recess sidewall 2321A. The urging end 12A that releases its urging on the recess sidewall 2321A moves to the buffer region 234A.

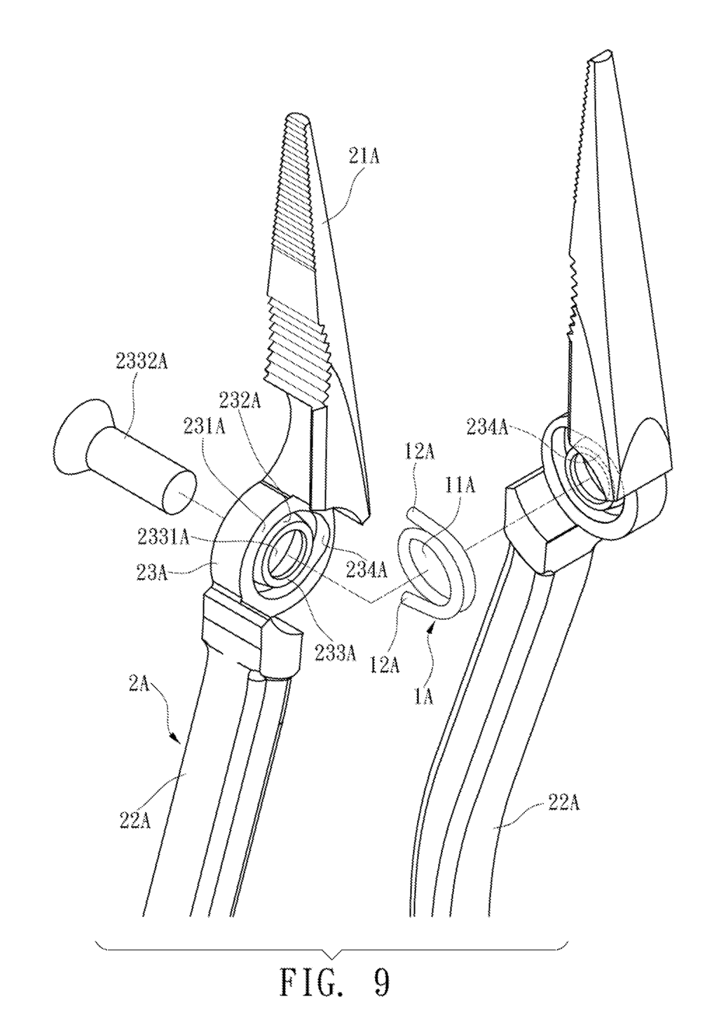

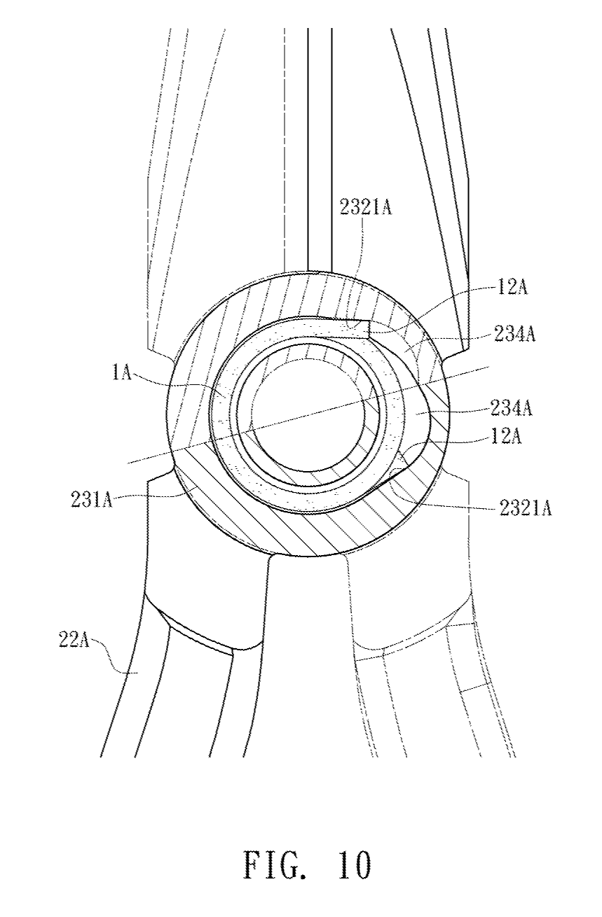

This embodiment differs from the first embodiment in that: each of the buffer regions 234A is formed transversely in the corresponding recess 232A. The opening direction of the two urging ends of the elastic element 1A is toward the side surfaces of the pliers, as shown in FIGS. 9 and 10.

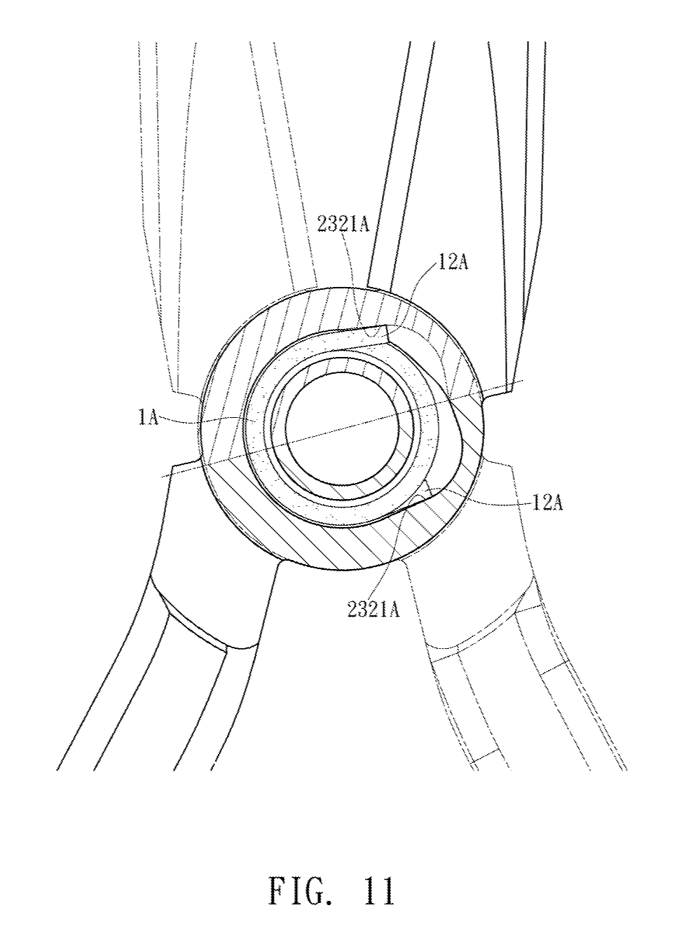

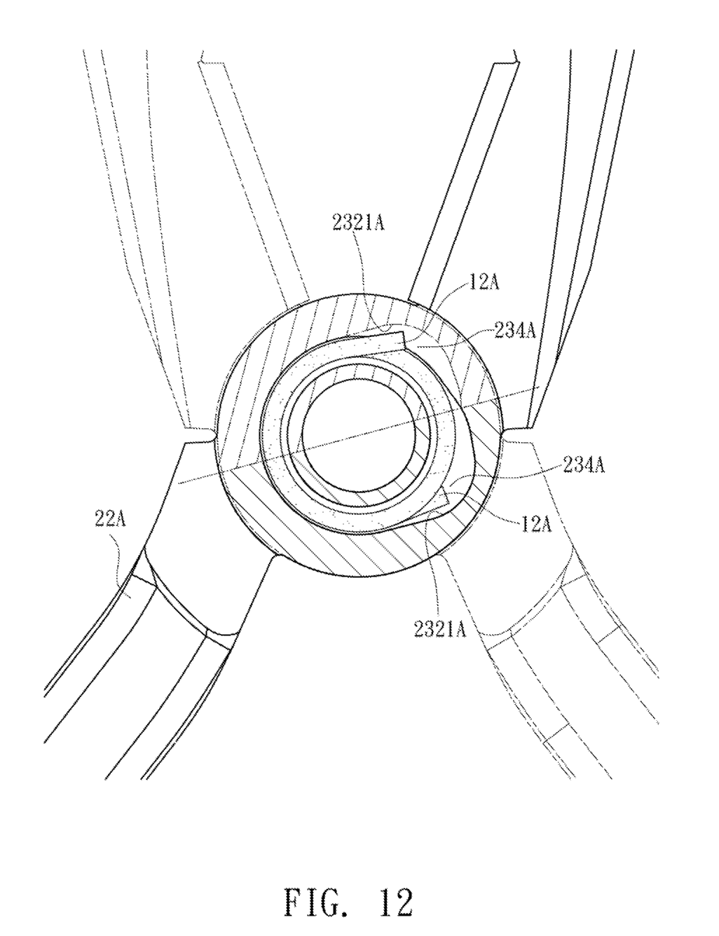

The operating method of this embodiment is basically the same as that of the first embodiment. FIG. 10 shows that the pliers are held tight so that the elastic element is squeezed. FIG. 11 shows that the pliers are opened to the maximum angle of the elastic element. FIG. 12 shows that the opening angle of the pliers is larger than the maximum angle of the elastic element. In this case, the elastic element does not further urge against the sidewalls of the recesses. The pliers are free to rotate more.

In summary, the first and second embodiments of the invention can achieve the following effects:

1. Since the elastic element and the pliers do not have the complete constraint relation as in the prior art, the elastic element is not further stretched when the pliers subtend a large angle. Instead, the pliers rotate more without any force on the elastic element. Therefore, this solves the problems of elastic fatigue, damages, and short lifetime with the elastic element.

2. Due to the limit in the opening angle of the elastic element, the pliers will not be opened to wide. The user can easily hold the pliers with a single hand. It is thus more convenient to hold and operate.

3. With the above-mentioned design, the user will not encounter such problems as soreness and numbness and long time use of the disclosed pliers.

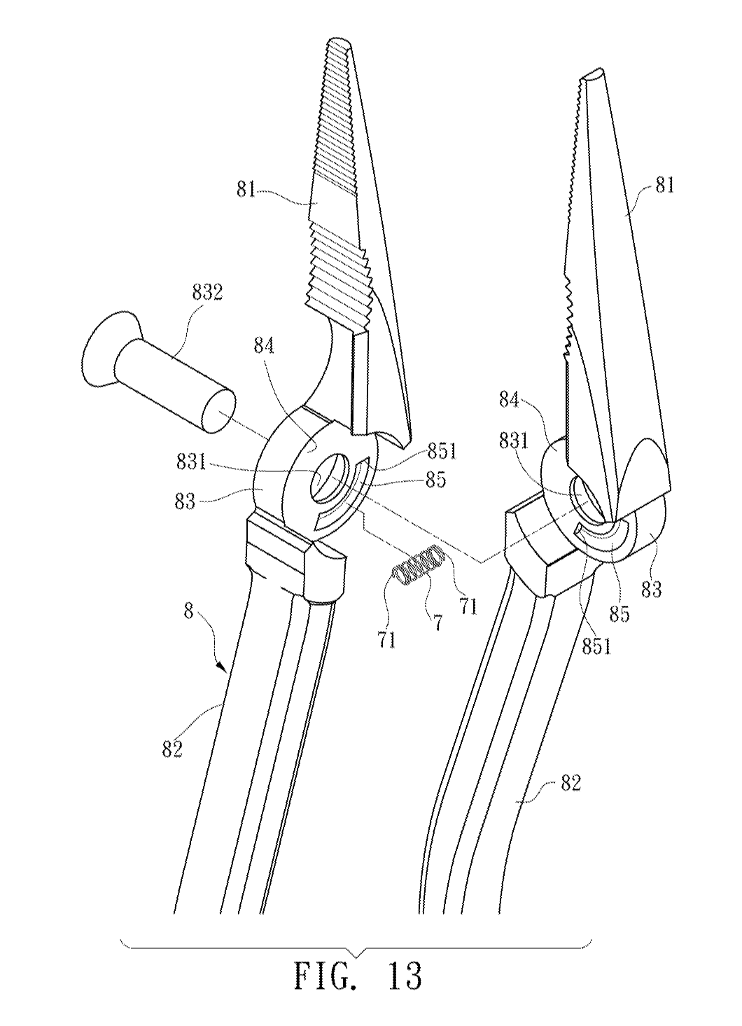

Moreover, the invention has a third embodiment shown in FIGS. 13 to 18. It includes an elastic element 7 and two pliers bodies 8.

Both sides of the elastic element 7 have an urging end 71, respectively. In this embodiment, the elastic element 7 is a compressive spring.

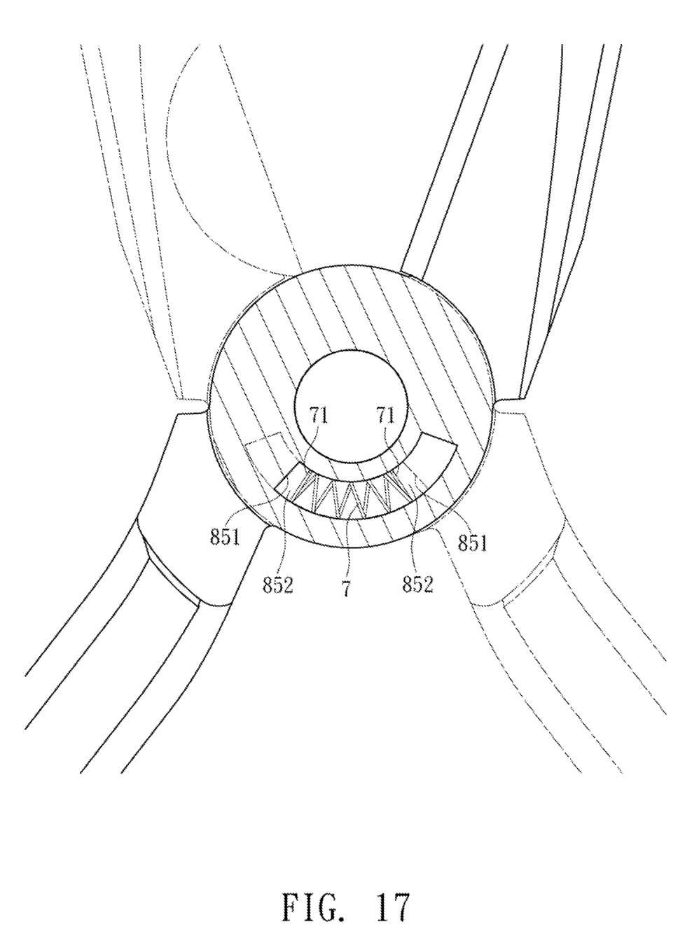

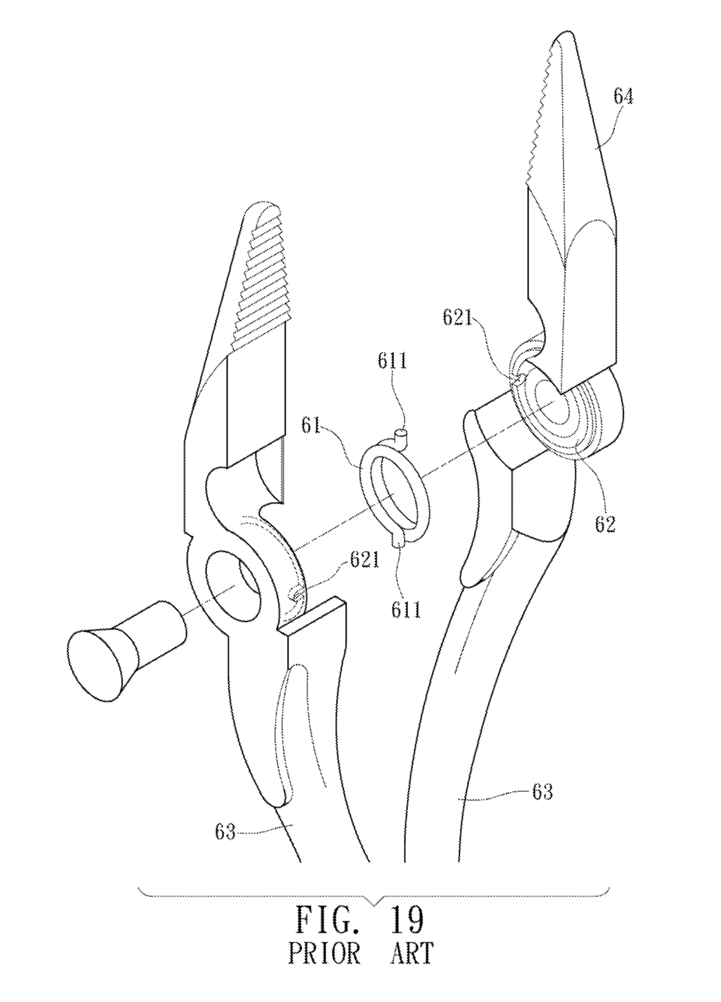

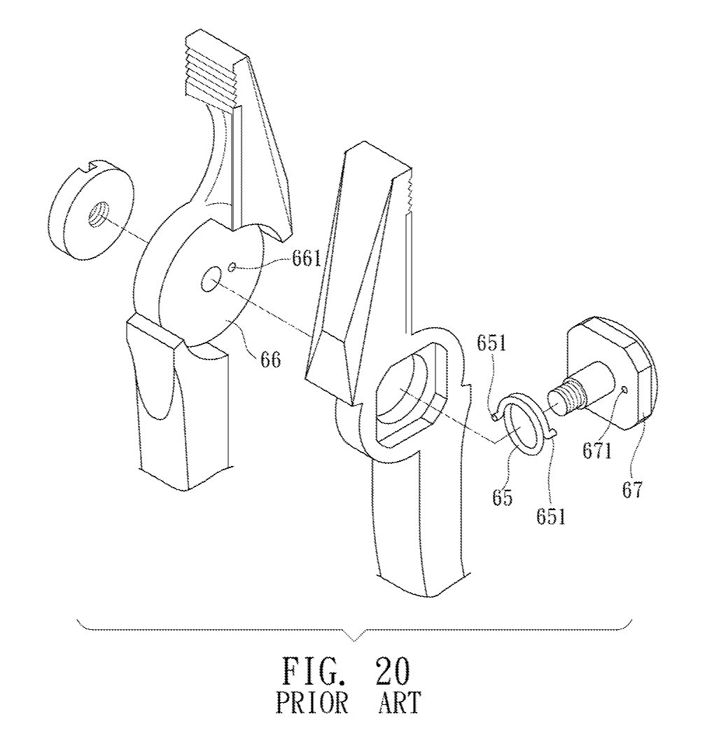

The two pliers bodies 8 have two pinching heads 81, two handles 82, and two pivotal parts 83 for the two pliers bodies 8 to cross each other. The two pivotal parts 83 have an urging surface 84, respectively. The two urging surfaces 84 are dug in to form recesses 85, respectively, that are surrounded and face each other. A pivotal hole 831 near the corresponding recess 85 goes through each of the two pivotal parts 83. The two pivotal holes 831 are connected by a pivotal element 832. The elastic element 7 is disposed in the two recesses 85 of the two pliers bodies 8. The elastic element 7 surrounds the peripheral of the pivotal element 832. The two urging ends 71 of the elastic element 7 are on opposite sides of the two recesses 85 to urge against the recess sidewalls 851, thus pushing the pliers open. A buffer region 852 is formed in the two recesses 85 corresponding to the two urging ends 71. As shown in FIGS. 17 and 18, when the opening angle of the pliers is greater than the maximum angle supported by the elastic element 7, at least one end of the two urging ends 71 of the elastic element 7 releases its urging on the recess sidewall 851. The urging end 71 that releases its urging on the recess sidewall 851 moves to the buffer region 852. In this embodiment, as shown in FIGS. 17 and 18, the two urging ends 71 of the elastic element 7 do not urge against the sidewalls 851 of the recesses 85 at the same tune. In practice, the relative positions of the elastic element 7 and the two recesses 85 are not fixed. They depend on the actual situation. The drawings show that the elastic element 7 can shift and wiggle therein.

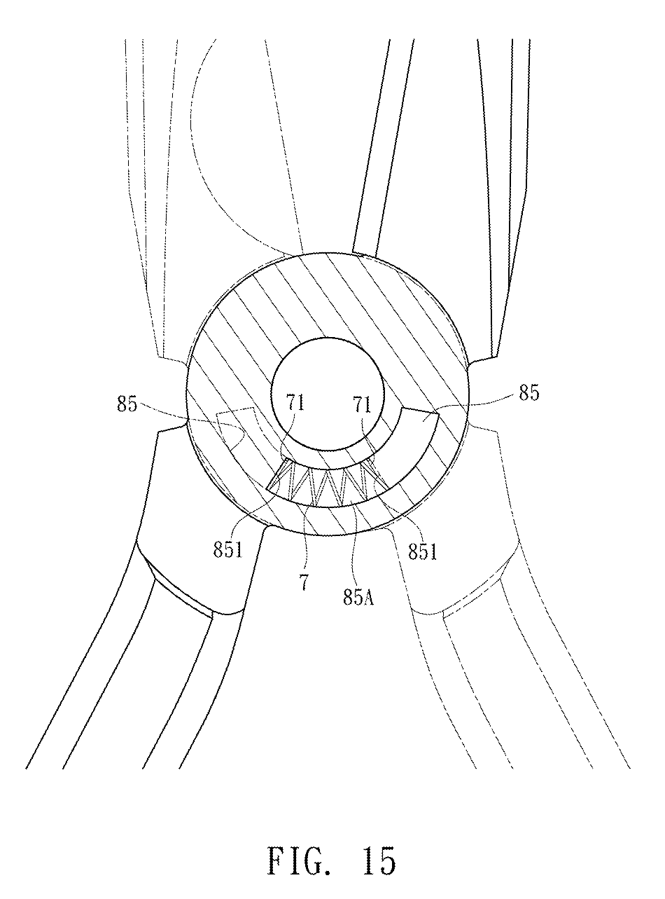

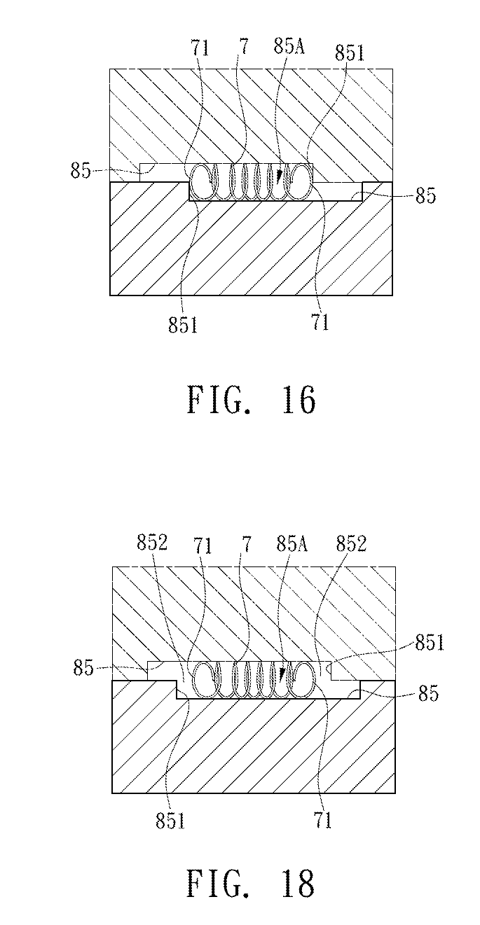

In this embodiment, each of the recesses 85 is a curved groove. The two recesses 85 together form an intersection region 85A. As shown in FIGS. 15 and 16, the elastic element is disposed in the intersection region 85A. The two urging ends 71 of the elastic element 7 urge against opposite sides of the two recesses 85.

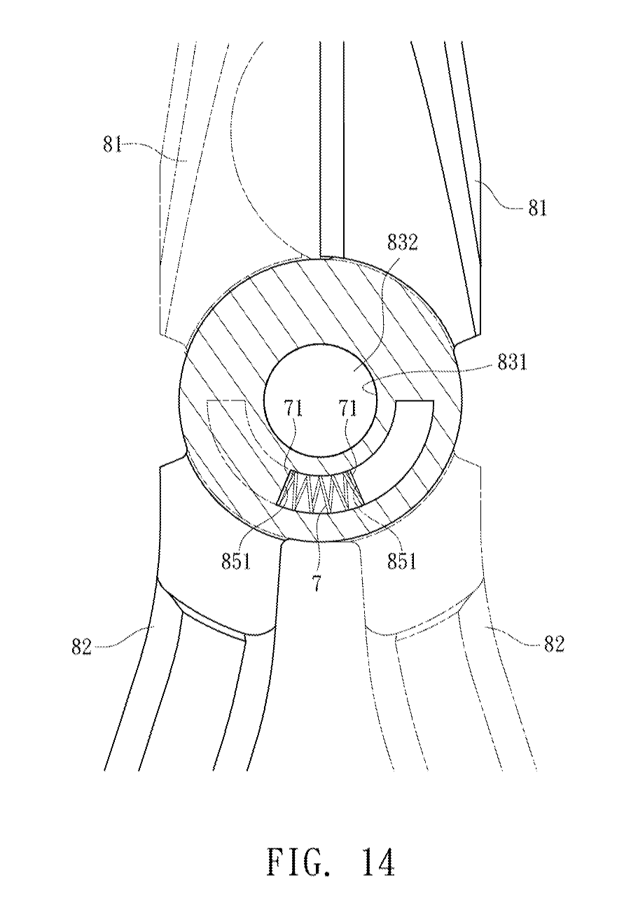

FIG. 14 shows the situation when the pliers are closed and the elastic element 7 is compressed. As shown in FIGS. 15 and 16, the pliers are relaxed and the elastic element 7 pushes the pliers open. The drawing shows the maximum angle of the pliers supported by the elastic element 7. FIGS. 17 and 18 show that the opening angle of the pliers exceeds the maximum angle supported by the elastic element 7. The pliers impose no force on the elastic element in this case.

Besides, the operating method of the pliers in the third embodiment is basically the same as the previous two embodiments. The third embodiment can achieve the same effects as the previous two embodiments. Please refer to the corresponding descriptions before.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. Pliers with a restoring function, comprising:
an elastic element, both sides of which have an urging end, respectively;
two pliers bodies having two pinching heads, two handles, and two pivotal parts for the two pliers bodies to cross each other;
wherein the two pivotal parts have respectively urging surfaces that face each other; the urging surfaces are formed with respectively recesses that are surrounded and face each other; a pivotal hole near the corresponding recess penetrates through each of the pivotal parts; a pivotal element penetrates through the two pivotal holes; the elastic element is disposed in the recesses of the two pliers bodies and surrounds the peripheral of the pivotal element; the two urging ends of the elastic element are on opposite sides of the two recesses to urge against sidewalls of the recesses, thus pushing the pliers open; a buffer region is formed in each of the two recesses corresponding to the two urging ends; when the opening angle of the pliers is greater than the maximum angle supported by the elastic element, at least one end of the two urging ends of the elastic element releases its urging against the corresponding recess sidewall so that no force is imposed on the pliers; and the urging end that releases its urging against the corresponding recess sidewall moves to the corresponding buffer region.

2. The pliers with a restoring function of claim 1, wherein each of the buffer regions is in the corresponding recess the vicinity of the corresponding handle, the elastic element is a torsional spring, and the opening directions of the two urging ends of the elastic element are toward between the two handles.

3. The pliers with a restoring function of claim 2, wherein the maximum angle of the elastic element is ½ to ⅓ that maximum angle of the pliers.

4. The pliers with a restoring function of claim 2, wherein each of the recesses has a protruding pillar that connects to each other and the center of the protruding pillar is penetrated with the pivotal holes.

5. The pliers with a restoring function of claim 2, wherein each of the two pinching heads extends a stopping part sideways so that the pivotal part is limited by the stopping part when the pliers open to the maximum angle.

6. The pliers with a restoring function of claim 1, wherein each of the buffer region is formed transversely in the corresponding recess, the elastic element is a torsional spring, and the opening directions of the two urging ends of the elastic element are toward the side surfaces of the pliers.

7. The pliers with a restoring function of claim 6, wherein each of the recesses has a protruding pillar that connects to each other and the center of the protruding pillar is penetrated with the pivotal holes.

8. The pliers with a restoring function of claim 1, wherein the elastic element is a compressive spring, each of the recesses is a curved groove, the two recesses form an intersection region, the elastic is disposed in the intersection region, and the two urging ends of the elastic element push opposite sides of the recesses.
